(19) United States
(12) Patent Application Publication
(10) Pub. No.: US 2024/0140448 A1
(43) Pub. Date: May 2, 2024

(54) Electronic Control Device, On-Vehicle Control System, and Redundant Function Control Method

(71) Applicant: Hitachi Astemo, Ltd., Hitachinaka-shi, Ibaraki (JP)

(72) Inventors: Momoka KASUYA, Tokyo (JP); Hiroki YAMAZAKI, Tokyo (JP); Mikio KATAOKA, Tokyo (JP); Nobuyoshi MORITA, Tokyo (JP); Kota IDEGUCHI, Tokyo (JP); Yasuhiro FUJII, Tokyo (JP)

(21) Appl. No.: 18/273,338

(22) PCT Filed: Aug. 26, 2021
(86) PCT No.: PCT/JP2021/031408

§ 371 Date: Jul. 20, 2023

(30) Foreign Application Priority Data
Jan. 22, 2021 (JP) 2021-009152

(51) Int. Cl. B60W 50/023; B60W 50/04; G06F 21/55

(52) U.S. Cl. CPC B60W 50/023; B60W 50/04; G06F 21/55

(57) ABSTRACT

An electronic control device 140 is mounted on an on-vehicle control system 10 that performs travel control of an automobile, and is communicatively connected to a plurality of control devices including a first control device (electronic control device 120) and a second control device (electronic control device 130). The electronic control device 140 includes an attack determination unit 145 that determines presence or absence of a security attack in each control device, and a redundant system execution determination unit 146 that determines whether to cause the second control device to execute a redundant function similar to or a part of the function performed by the first control device based on the result of determination by the attack determination unit 145.

### TECHNICAL FIELD

The present invention relates to an electronic control device, an on-vehicle control system, and a redundant function control method, and is suitably applied to an electronic control device mounted on an on-vehicle control system of an automobile, an on-vehicle control system, and a redundant function control method.

### BACKGROUND ART

Conventionally, in an on-vehicle system, in order to guarantee the safety of a driver even when a system fails, a redundant function capable of continuing driving in preparation for a case where any failure occurs is arranged in the system.

As a technique corresponding to the above-described failure of the on-vehicle system, for example, PTL 1 discloses a method in which, in order to continue traveling of an automobile even when a function of an electronic control device does not normally operate due to a failure, in addition to a function at a normal time (normal system), a function similar to that at the normal time is provided as a redundant function (redundant system), and the redundant function is operated at the time of the failure.

### CITATION LIST

### Patent Literature

PTL 1: JP 2005-332064 A

### SUMMARY OF INVENTION

### Technical Problem

Meanwhile, in recent years, although the on-vehicle network is connected to an external network (for example, the Internet or WiFi (registered trademark)) and the convenience of the user is improved, a risk that an electronic control unit (ECU) fails due to a cyberattack (security attack) from the outside of the vehicle, which has not been considered in the conventional on-vehicle system, has been pointed out.

However, the technique disclosed in PTL 1 does not consider a case where a function stops due to a security attack, and there is a possibility that a driver is put in danger by operating a redundant system to continue traveling of an automobile. That is, when the function of the normal system stops due to the security attack, there is a possibility that a redundant system having a function similar to that of the normal system is also subjected to the security attack. However, PTL 1 does not consider such a risk.

The present invention has been made in view of the above points, and it is an object of the present invention to propose an electronic control device, an on-vehicle control system, and a redundant function control method that enable continuation of travel control (for example, automatic driving) of an automobile by an on-vehicle control system while ensuring safety by distinguishing whether a cause of a case where a normal operation cannot be performed is caused by a security attack so as to determine an appropriate coping method, and that can improve security safety at the time of activation of a redundant system while maintaining travel control of the automobile.

### Solution to Problem

In order to solve such a problem, the present invention provides an electronic control device mounted on an on-vehicle control system that performs travel control of an automobile and communicatively connected to a plurality of control devices including a first control device and a second control device. The electronic control device includes: an attack determination unit that determines presence or absence of a security attack in each control device of the plurality of control devices; and a redundant system execution determination unit that determines, based on a result of determination by the attack determination unit, whether to cause the second control device to alternatively execute a redundant function similar to the function performed by the first control device or a part of the function.

Further, in order to solve such a problem, the present invention provides an on-vehicle control system that performs travel control of an automobile. The on-vehicle control system includes: a plurality of control devices that include a first control device having a predetermined function and a second control device having a redundant function similar to the function or a part of the function; and an electronic control device that is communicatively connected to the plurality of control devices. The electronic control device includes: an attack determination unit that determines presence or absence of a security attack in each control device of the plurality of control devices; and a redundant system execution determination unit that determines, based on a result of determination by the attack determination unit, whether to cause the second control device to alternatively execute the redundant function corresponding to the function performed by the first control device.

Further, in order to solve such a problem, the present invention provides a redundant function control method by an electronic control device mounted on an on-vehicle control system that performs travel control of an automobile and communicatively connected to a plurality of control devices including a first control device and a second control device. The method includes: determining presence or absence of a security attack in each control device of the plurality of control devices; and determining, based on a result of determination of the determining of an attack, whether to cause the second control device to execute a redundant function similar to the function performed by the first control device or a part of the function.

### Advantageous Effects of Invention

According to the present invention, it is possible to improve security safety at the time of starting a redundant system while maintaining travel control (for example, automatic driving) of an automobile by an on-vehicle control system.

### BRIEF DESCRIPTION OF DRAWINGS

FIG. 1 is a block diagram illustrating a configuration example of an on-vehicle control system 10 according to a first embodiment of the present invention.

FIG. 2 is a flowchart illustrating a processing procedure example of reception-time processing executed by the electronic control device 140 at the time of data reception.

FIG. 3 is a flowchart illustrating a detailed processing procedure example of failure processing.

FIG. 4 is a diagram illustrating an example of an infringement estimation degree DB 150.

FIG. 5 is a diagram illustrating an example of an attack determination DB 151.

FIG. 6 is a diagram illustrating an example of a redundant system operating destination DB 152.

FIG. 7 is a block diagram illustrating a configuration example of an on-vehicle control system 20 according to a second embodiment of the present invention.

FIG. 8 is a flowchart illustrating a processing procedure example of processing by a redundant system execution determination unit 246.

FIG. 9 is a diagram illustrating an example of an attack path DB 250.

FIG. 10 is a block diagram illustrating another example of a connection configuration of an electronic control device in the on-vehicle control system 20.

FIG. 11 is a diagram illustrating an example of an attack path DB 250A in the connection configuration of FIG. 10.

FIG. 12 is a block diagram illustrating a configuration example of an on-vehicle control system 30 according to a third embodiment of the present invention.

FIG. 13 is a flowchart illustrating a detailed processing procedure example of failure processing in the third embodiment.

FIG. 14 is a diagram illustrating an example of a rearrangement destination DB 350.

### DESCRIPTION OF EMBODIMENTS

Hereinafter, embodiments of the present invention will be described in detail with reference to the drawings.

### (1) First Embodiment

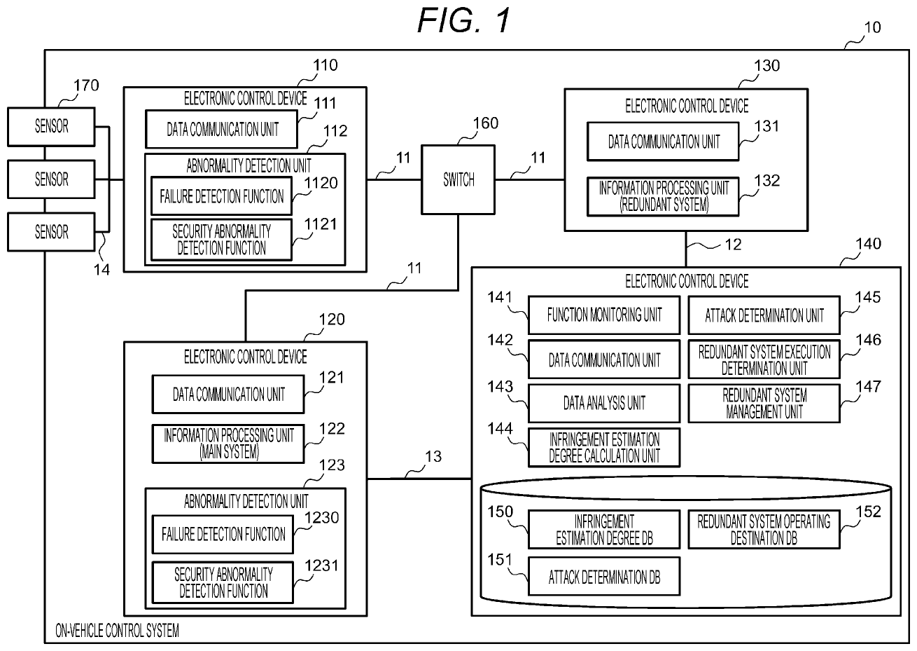

FIG. 1 is a block diagram illustrating a configuration example of an on-vehicle control system 10 according to a first embodiment of the present invention. The on-vehicle control system 10 is a system for controlling traveling of an automobile, and is, for example, a system for controlling automatic driving. As illustrated in FIG. 1, the on-vehicle control system 10 includes electronic control devices 110, 120, 130, and 140, a switch 160, and a sensor 170.

The electronic control devices 110, 120, 130, and 140 is one of electronic control devices mounted inside an automobile, and is specifically an ECU or a gateway. In each of the electronic control devices 110 to 140, a program and a database are stored in a general recording medium such as a random access memory (RAM) or a read only memory (flash ROM), and a part thereof may be stored in an external memory.

The components in the on-vehicle control system 10 are communicatively connected via communication buses 11 to 14 or the switch 160. The communication buses 11 to 14 are connected to the electronic control devices 110 to 140 inside the on-vehicle control system 10, and a bus type or a star type network may be constructed using the switch 160 as appropriate. As a standard of the communication buses 11 to 14, a controller area network (CAN), Ethernet (registered trademark), a local interconnect network (LIN), or the like is generally used. Hereinafter, it is assumed that Ethernet is used for the communication buses 11, 12, and 13 as an example.

Specifically, in the case of FIG. 1, the electronic control device 110 is connected to the electronic control devices 120 and 130 via the communication bus 11 and the switch 160, and is connected to the plurality of sensors 170 via the communication bus 14. Further, the electronic control device 140 is connected to the electronic control device 130 via the communication bus 12, and is connected to the electronic control device 120 via the communication bus 13. Note that, in the present example, it is assumed that the electronic control device 110 is connected to the sensor 170, but the electronic control device 110 may be connected to another external device.

Note that, in the case of FIG. 1, the on-vehicle control system 10 includes the four electronic control devices 110, 120, 130, and 140. However, the on-vehicle control system according to the present embodiment or another embodiment to be described later does not necessarily include the four electronic control devices, and the configuration may be changed as appropriate. For example, the electronic control device 110 can omit the electronic control device 120 from the configuration when the sensor 170 is connected to the electronic control device 110. Further, the function of the electronic control device may be integrated into one or several electronic control devices. For example, when the function of the electronic control device 130 can be substituted by other electronic control devices 110, 120, and 140, the electronic control device 130 can be omitted from the configuration.

Hereinafter, each component of the on-vehicle control system 10 will be described in detail.

The electronic control device 110 has a function of receiving collected data collected by the sensor 170, confirming (detecting) the collected data and an abnormality inside the electronic control device 110, and transmitting a detection result to the electronic control devices 120 and 130. The electronic control device 110 includes a data communication unit 111 and an abnormality detection unit 112.

The data communication unit 111 receives collected data from the sensor 170 and transmits predetermined data to the electronic control devices 120 and 130 via the communication bus 11 and the switch 160. The data transmitted by the data communication unit 111 may include collected data received from the sensor 170 in addition to the data indicating the detection result by the abnormality detection unit 112.

The abnormality detection unit 112 includes a failure detection function 1120 and a security abnormality detection function 1121, and detects collected data and an abnormality inside the electronic control device 110.

The failure detection function 1120 is a function of detecting a failure in the electronic control device 110. The failure detection function 1120 outputs failure detection information as data indicating a detection result of the failure, and the failure detection information is transmitted to the electronic control devices 120 and 130 by the data communication unit 111.

The security abnormality detection function 1121 is a function of detecting collected data from the sensor 170 and an abnormality in security in the electronic control device 110. The security abnormality detection function 1121 outputs abnormality detection information as data indicating a detection result of the abnormality, and the abnormality detection information is transmitted to the electronic control devices 120 and 130 by the data communication unit 111.

The electronic control device 120 has a function of receiving data from the electronic control device 110, confirming (detecting) the received data and an abnormality in the electronic control device 120, and transmitting the detection result to the electronic control device 140, and a function of transferring data received from the electronic control device 110 to the electronic control device 140. The electronic control device 120 includes a data communication unit 121, an information processing unit 122 of a main system, and an abnormality detection unit 123.

Similarly to the data communication unit 111, the data communication unit 121 has a function of transmitting and receiving data. Further, the data communication unit 121 also has a function of transferring the failure detection information and the abnormality detection information received from the electronic control device 110 to the electronic control device 140 via the communication bus 13.

The information processing unit 122 of the main system has a function of processing data received from the electronic control device 110.

The abnormality detection unit 123 includes a failure detection function 1230 and a security abnormality detection function 1231, and has the same function as the abnormality detection unit 112. That is, the failure detection function 1230 is a function of detecting a failure in the electronic control device 120, and outputs failure detection information as data indicating the detection result of the failure. In addition, the security abnormality detection function 1231 is a function of detecting collected data from the sensor 170 and an abnormality in security in the electronic control device 120, and outputs abnormality detection information as data indicating a detection result of the abnormality. The failure detection information and the abnormality detection information output by each function of the abnormality detection unit 123 are transmitted by the data communication unit 121 to the electronic control device 140 via the communication bus 13.

The electronic control device 130 has a function of receiving data from the electronic control device 110, performing predetermined data processing, and transmitting a processing result to the electronic control device 140, and a function of transferring data received from the electronic control device 110 to the electronic control device 140. The electronic control device 130 includes a data communication unit 131 and an information processing unit 132 of a redundant system. The electronic control device 130 is a device that operates a redundant system (information processing unit 122) when the function of the information processing unit 132 of the main system is stopped in the electronic control device 120. However, the data processing performed by the information processing unit 132 of the electronic control device 130 may be different from the data processing performed by the information processing unit 122 of the electronic control device 120.

The data communication unit 131 has a function of transmitting and receiving data similarly to the data communication units 111 and 121. Further, the data communication unit 131 may have a function of transferring the failure detection information and the abnormality detection information received from the electronic control device 110 to the electronic control device 140 via the communication bus 12.

The information processing unit 132 of the redundant system has a function of substituting a function similar to or a part of the function of the information processing unit 122 as a redundant function of the function of the information processing unit when it is determined that proper processing is difficult due to a failure or a security attack in data processing in the information processing unit 122 of the main system.

The electronic control device 140 has a function of aggregating the failure detection information and the abnormality detection information received from the electronic control device 120 or the electronic control device 130, determining whether the electronic control devices 110 and 120 are attacked and whether the electronic control devices are operating normally by using the aggregated information, and determining whether to operate the information processing unit 132 of the redundant system by using the result of determinations.

The electronic control device 140 includes a function monitoring unit 141, a data communication unit 142, a data analysis unit 143, an infringement estimation degree calculation unit 144, an attack determination unit 145, a redundant system execution determination unit 146, a redundant system management unit 147, an infringement estimation degree database (DB) 150, an attack determination database (DB) 151, and a redundant system operating destination database (DB) 152.

The function monitoring unit 141 has a function of monitoring the operation of the electronic control devices 110, 120, and 130 in the on-vehicle control system 10 and determining whether it is a state in which function substitution is necessary. Examples of the monitoring method include a method of monitoring based on a reception status of data from a target electronic control device in a preset predetermined time, and a method of monitoring by transmitting data for confirming an operation from the electronic control device 140 to each electronic control device.

Similarly to the data communication units 111, 121, and 131, the data communication unit 142 has a function of transmitting and receiving data.

The data analysis unit 143 has a function of determining the type of data received by the data communication unit 142. The type of the received data can be classified into at least failure detection information, abnormality detection information, and control information. Further, in a case where the received data is abnormality detection information, the data analysis unit 143 also identifies the electronic control device that has detected the abnormality.

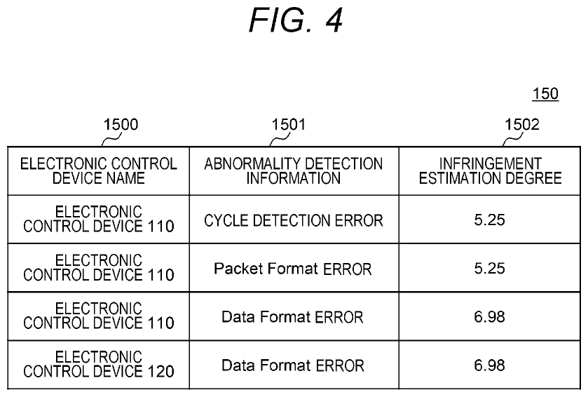

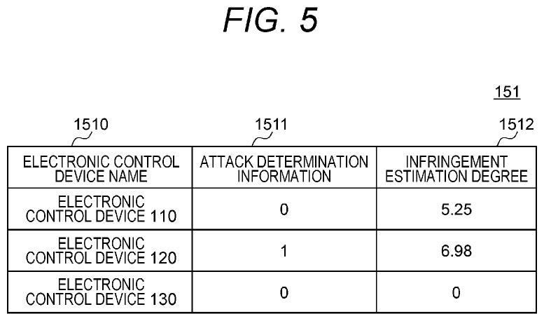

The infringement estimation degree calculation unit 144 has a function of calculating an infringement estimation degree used when determining whether each electronic control device is attacked by using the abnormality detection information received by the electronic control device 140, and updating the infringement estimation degree held by the electronic control device 140 based on the calculation result. The infringement estimation degree DB 150 (see FIG. 4 for details) is used to calculate the infringement estimation degree, and the infringement estimation degree in each electronic control device is stored in the attack determination DB 151 (see FIG. 5 for details). As an example of a method of calculating the infringement estimation degree, there is a method of adding the infringement estimation degree for each abnormality detection information or each attack type.

The attack determination unit 145 has an attack determination function of determining whether each electronic control device is attacked using the infringement estimation degree calculated by the infringement estimation degree calculation unit 144. Specific examples of the determination criterion of the attack determination include that the infringement estimation degree exceeds a predetermined threshold and that specific abnormality detection information defined in advance is received. Information indicating a result of the attack determination on each electronic control device is registered in the attack determination DB 151 as attack determination information.

The redundant system execution determination unit 146 has a function of determining whether to activate the redundant system for the corresponding electronic control device based on the result of the attack determination on the target electronic control device. The attack determination information stored in the attack determination DB 151 is used to determine the activation of the redundant system. Note that, in a case where it is desired to define the rules at the time of starting the redundant system in detail, the rules of the redundant system function may be separately defined in the database. As a specific example of the rule, there is a rule that the redundant system is not activated when it is necessary to operate the redundant system in a plurality of functions.

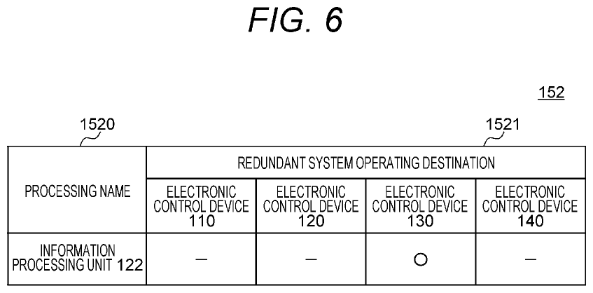

When the redundant system execution determination unit 146 determines to operate the redundant system, the redundant system management unit 147 has a function of determining an operating destination of the redundant system, and issuing an operation instruction to the electronic control device at the operating destination. The redundant system operating destination DB 152 (see FIG. 6 for details) is used to determine the operating destination of the redundant system.

The infringement estimation degree DB 150 stores an infringement estimation degree for abnormality detection information received by the electronic control device 140 from each of the electronic control devices 110 to 130. The infringement estimation degree DB 150 is used when the data communication unit 142 receives the abnormality detection information and the infringement estimation degree calculation unit 144 calculates and updates the infringement estimation degree. The data structure of the infringement estimation degree DB 150 will be described later with reference to FIG. 4.

The attack determination DB 151 stores attack determination information and an infringement estimation degree for each of the electronic control devices 110 to 130. The data structure of the attack determination DB 151 will be described later with reference to FIG. 5.

The redundant system operating destination DB 152 stores information regarding an operating destination of the redundant system to be activated when the function of each of the electronic control devices 110 to 130 fails. The redundant system operating destination DB 152 is used when the redundant system management unit 147 issues an operation instruction to the operating destination of redundant system. The data structure of the redundant system operating destination DB 152 will be described later with reference to FIG. 6.

The switch 160 is a device having a function of transferring received information to an appropriate electronic control device. Specifically, for example, the switch 160 can transfer information transmitted from the electronic control device 110 via the communication bus 11 to the electronic control device 120 and the electronic control device 130 via the communication bus 11, but can change the electronic control device 120 to the transfer destination at the time of normal operation (when the main system is operating) and change the electronic control device 130 to the transfer destination at the time of operating the redundant system. Note that the switch 160 may be included in an electronic control device (for example, the electronic control device 110).

The sensor 170 is various sensors having a function of collecting information necessary for automatic driving control by the on-vehicle control system 10, and is specifically, for example, a camera, a radar, a light detection and ranging (LiDAR), or the like. Note that the sensor 170 may be a connection function with the Internet, Bluetooth (registered trademark), or the like that can be an entry point of an attack.

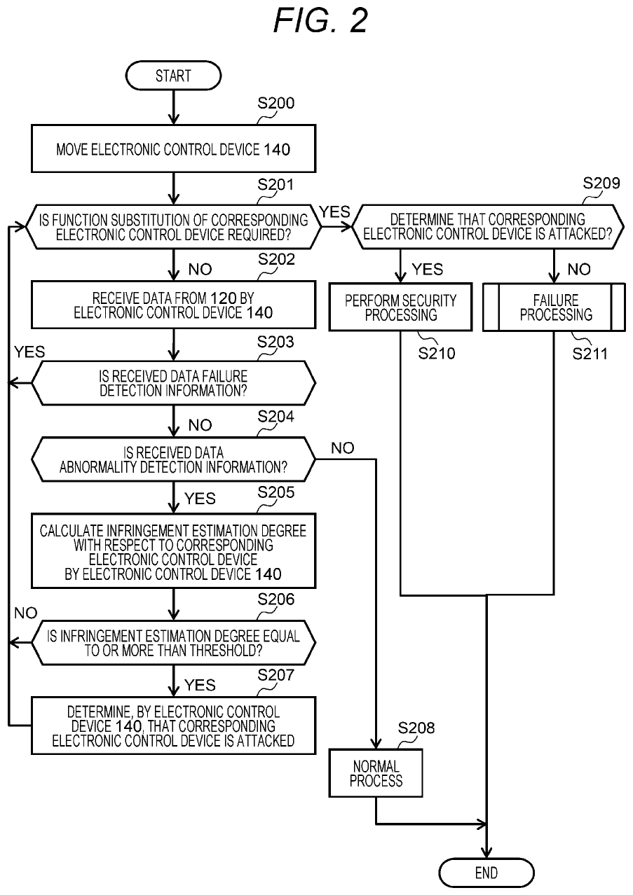

FIG. 2 is a flowchart illustrating a processing procedure example of reception-time processing executed by the electronic control device 140 when data is received. Although FIG. 2 illustrates the processing procedure in a case where the electronic control device 140 receives data from the electronic control device 120, the present invention can be similarly applied to processing in a case where data is received from another electronic control device (for example, the electronic control device 130) of the on-vehicle control system 10.

According to FIG. 2, first, in step S200, power is input to the electronic control device 140, and after the electronic control device 140 is operated, data exchange is started among the electronic control devices 110 to 140 (and the sensors 170). Note that the processing of step S201 and subsequent steps may be considered to be repeatedly executed periodically or at a predetermined trigger when the electronic control device 140 operates. Examples of the predetermined trigger include a case where data from another electronic control device is received, a case where data is not received at an assumed timing, a case where data for synchronization is transmitted from the electronic control device 140 to another electronic control device, and the like.

In step S201, the function monitoring unit 141 of the electronic control device 140 checks whether the electronic control device (in the present example, the electronic control device 120) that is likely to activate the redundant system is in a state requiring function substitution. Specific examples of the situation to be checked here include a situation in which data has not been received from the target electronic control device (corresponding electronic control device) for a certain period of time, and a situation in which an inquiry is made from the electronic control device 140 as to whether function substitution is necessary, and a situation in which a response indicating that function substitution is necessary is received from the corresponding electronic control device. When the electronic control device 140 determines that the function substitution of the corresponding electronic control device is necessary (YES in step S201), the process proceeds to step S209, and when the function substitution of the corresponding electronic control device is not necessary (NO in step S201), the process proceeds to step S202.

In step S202, the electronic control device 140 receives data from the electronic control device 120.

In the next step S203, the data analysis unit 143 checks whether the data received in step S202 is failure detection information. When the received data is the failure detection information (YES in step S203), the process proceeds to step S201, and it is confirmed whether the function substitution is necessary. When the received data is not the failure detection information (NO in step S203), the process proceeds to step S204.

In step S204, the data analysis unit 143 confirms whether the data received in step S202 is abnormality detection information. When the received data is abnormality detection information (YES in step S204), the process proceeds to step S205. When the received data is not the abnormality detection information (NO in step S204), combining with the confirmation result in step S203 means that the received data is the control information. Therefore, the process proceeds to step S208, the processing instructed by the received data is performed, and the current reception-time processing ends.

In step S205, the infringement estimation degree calculation unit 144 calculates the infringement estimation degree with respect to the data received in step S202 and updates the infringement estimation degree stored in the infringement estimation degree DB 150. The infringement estimation degree calculation unit 144 calculates and updates the infringement estimation degree using the infringement estimation degree DB 150 based on the control information of the electronic control device that has detected the abnormality and the abnormality detection information. For example, even in the case of data received from the electronic control device 120, when the electronic control device 110 detects an abnormality, the infringement estimation degree regarding the electronic control device 110 is updated. Note that, as an example of a method of calculating the infringement estimation degree, there is a method of adding the infringement estimation degree every time abnormality detection information is received.

In the next step S206, the attack determination unit 145 determines whether the electronic control device (corresponding electronic control device) from which the infringement estimation degree is derived in step S205 is attacked, and determines whether the infringement estimation degree is a predetermined threshold or more. Examples of a method of determining the predetermined threshold include a method of determining the predetermined threshold in advance based on the number of times or the degree of importance of the abnormality detection information received by the electronic control device 140. When the infringement estimation degree is equal to or more than the threshold (YES in step S206), the process proceeds to step S207, and when the infringement estimation degree is less than the threshold (NO in step S206), the process proceeds to step S201.

In step S207, the attack determination unit 145 makes an attack determination that the corresponding electronic control device of which the infringement estimation degree is equal to or greater than the threshold in step S206 is attacked, and registers a result of the attack determination in the attack determination DB 151. Note that, when the attack determination is made, processing such as discarding data or prohibiting reprogramming in the corresponding electronic control device may be performed. After the processing of step S207, the process proceeds to step S201.

On the other hand, as described above, when the electronic control device 140 determines in step S201 that function substitution of the corresponding electronic control device is necessary (YES in step S201), the processing of step S209 is performed. In step S209, the redundant system execution determination unit 146 refers to the attack determination DB 151 to confirm whether the corresponding electronic control device that requires function substitution has been determined to be attacked. When the processing of step S207 is executed in advance and the corresponding electronic control device is determined to be attacked, the attack determination is registered in the attack determination DB 151. In this case (YES in step S209), the redundant system execution determination unit 146 determines not to activate the redundant system of the corresponding electronic control device, and the process proceeds to step S210. On the other hand, when the corresponding electronic control device is not determined to be attacked (NO in step S209), the redundant system execution determination unit 146 determines to activate the redundant system of the corresponding electronic control device, and the process proceeds to step S211.

In step S210, the electronic control device 140 (for example, the redundant system management unit 147) performs security processing on the corresponding electronic control device. As described above, when the security processing is performed, the electronic control device 130 (information processing unit 132) of the redundant system is not operated. Specific examples of the security processing include changing a setting so as not to receive predetermined data, shifting to a shrinking operation with limited functions, and notifying a management center of an abnormality, and a plurality of these processes may be performed. Note that the security processing is performed by, for example, the redundant system management unit 147, but may be performed by an arbitrary processing unit included in the electronic control device 140.

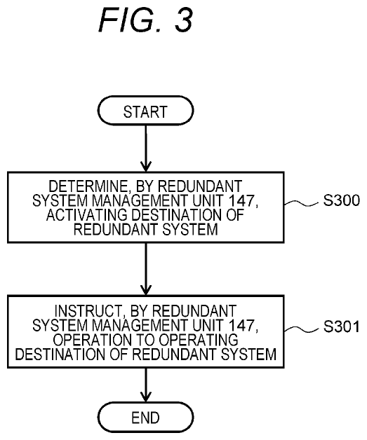

In step S211, the electronic control device 140 (for example, the redundant system management unit 147) performs failure processing on the corresponding electronic control device. In the failure processing, for example, in a case where the failure processing is performed on the information processing unit 122 of the main system of the electronic control device 120, a function similar to or a part of the function is operated in another electronic control device as a redundant function of the function of the information processing unit 122. In the example of FIG. 1, the function is replaced with the information processing unit 132 of the electronic control device 130 having the same function as the information processing unit 122 of the main system. A specific processing procedure example of the failure processing will be described later with reference to FIG. 3. Note that the failure processing is performed by, for example, the redundant system management unit 147, but may be performed by an arbitrary processing unit included in the electronic control device 140.

As described above, in a case where data is received from another electronic control device, the electronic control device 140 performs the processing illustrated in FIG. 2, so that it is possible to perform appropriate processing such as substituting the function of the electronic control device according to the situation of the failure or the security attack from the type of the received data and the content thereof.

FIG. 3 is a flowchart illustrating a detailed processing procedure example of the failure processing. The failure processing is processing performed by the electronic control device 140 (for example, the redundant system management unit 147) in step S211 of FIG. 2.

When the execution of the failure processing is determined, first, the redundant system management unit 147 determines the operating destination (activating destination) of the redundant system using the redundant system operating destination DB 152 (step S300).

Next, the redundant system management unit 147 prepares for the redundant system operation, and issues an operation instruction to the operating destination of the redundant system determined in step S300 (step S301). When the operating destination of the redundant system determined in step S300 is a configuration other than the electronic control device 140, the redundant system management unit 147 transmits an operation instruction to the electronic control device including the operating destination.

FIG. 4 is a diagram illustrating an example of the infringement estimation degree DB 150. The infringement estimation degree DB 150 stores information used for calculation of the infringement estimation degree, and specifically, in the case of FIG. 4, includes data items of an electronic control device name 1500, abnormality detection information 1501, and an infringement estimation degree 1502.

In the electronic control device name 1500, the electronic control device name having a possibility of detecting abnormality detection information is described, and the names of all the electronic control devices including an abnormality detection unit (for example, the abnormality detection units 112 and 123) having a function of detecting a failure or an abnormality in the electronic control device are registered.

The type of the abnormality detection information received by the electronic control device 140 is described in the abnormality detection information 1501. In the present embodiment, the coping method performed after the attack determination is made in step S207 in FIG. 2 may be set to be different according to the type of the abnormality detection information.

In the infringement estimation degree 1502, an infringement estimation degree determined according to a combination of an electronic control device (electronic control device name 1500) in which an abnormality is detected and the type of abnormality examination information (abnormality detection information 1501) is described. The infringement estimation degree 1502 is allocated in advance according to the degree of importance of the abnormality detection information (as the degree of importance is higher, the infringement estimation degree is also higher), and the degree of importance is determined based on, for example, the likelihood of occurrence of an abnormality and the severity of damage due to the abnormality.

FIG. 5 is a diagram illustrating an example of the attack determination DB 151. The attack determination DB stores, for each electronic control device, the infringement estimation degree calculated by the infringement estimation degree calculation unit 144 and information indicating a result of the attack determination determined by the attack determination unit 145. Specifically, in the case of FIG. 5, the attack determination DB 151 includes data items of an electronic control device name 1510, attack determination information 1511, and an infringement estimation degree 1512.

Similarly to the electronic control device name 1500, the electronic control device name 1510 describes an electronic control device name that may detect abnormality detection information.

The attack determination information 1511 stores information indicating a result of the attack determination regarding whether the electronic control device has been attacked. As an example of the attack determination information 1511, it is assumed that “0” is registered in a case where no attack determination is made (that is, in a normal state), and “1” is registered in a case where the attack determination is made in step S207 of FIG. 2.

The infringement estimation degree calculated by the infringement estimation degree calculation unit 144 is stored in the infringement estimation degree 1512. The stored infringement estimation degree 1512 is used at the time of attack determination. The infringement estimation degree 1512 is updated by calculating the infringement estimation degree of the corresponding electronic control device in which the abnormality detection information is detected every time the electronic control device 140 receives the abnormality detection information.

Specifically, the attack determination DB 151 in FIG. 5 illustrates an example of a case where an abnormality of a “cycle detection error” is detected in the electronic control device 110 and an abnormality of a “data format error” is detected in the electronic control device 120. In addition, an initial value of the infringement estimation degree 1512 is set to “0”, and a threshold as a reference of attack determination is set to “6.0”. At this time, referring to the infringement estimation degree DB 150 in FIG. 4, since the infringement estimation degree 1502 corresponding to the “cycle detection error” detected by the electronic control device 110 is “5.25”, “5.25” is registered in the infringement estimation degree 1512 of the electronic control device 110 in the attack determination DB 151. Then, since the infringement estimation degree 1512 of “5.25” is less than the threshold “6.0”, no attack determination is made, and the attack determination information 1511 of the electronic control device 110 is “0”. On the other hand, referring to the infringement estimation degree DB 150 in FIG. 4, since the infringement estimation degree 1502 corresponding to the “data format error” detected by the electronic control device 120 is “6.98”, “6.98” is registered in the infringement estimation degree 1512 of the electronic control device 120 in the attack determination DB 151. Then, since the infringement estimation degree 1512 of “6.98” is equal to or greater than the threshold “6.0”, the attack determination is made, and the attack determination information 1511 of the electronic control device 120 is “1”.

FIG. 6 is a diagram illustrating an example of the redundant system operating destination DB 152. The redundant system operating destination DB 152 stores information on the operating destination of the redundant system. Specifically, in the case of FIG. 6, the redundant system operating destination DB includes data items of a processing name 1520 and a redundant system operating destination 1521 implemented in each electronic control device.

The processing name 1520 stores a processing name implemented in an electronic control device in the on-vehicle control system 10. However, the processing name stored in the processing name 1520 is limited to processing designed as processing that may operate a redundant system when an abnormality occurs in a preliminary design stage. FIG. 6 illustrates an example in which the information processing unit 122 of the main system mounted on the electronic control device 120 is registered in the processing name 1520.

Information on the electronic control device that operates the redundant system is registered in the redundant system operating destination 1521 when a failure occurs in the processing registered in the processing name 1520 and the normal operation cannot be performed. In the redundant system operating destination 1521 of FIG. 6, an example is illustrated in which the electronic control device 130 on which the redundant system information processing unit 132 is mounted is marked with “o”, whereby the electronic control device 130 is registered as a redundant system activating destination of the information processing unit 122.

Specifically, in a case where the execution of the failure processing illustrated in FIG. 3 is determined in a case where the function provided by the information processing unit 122 fails in the electronic control device 120, the redundant system management unit 147 can determine the electronic control device 130 as a redundant system operating destination with reference to the redundant system operating destination DB 152 in FIG. 6. Then, the redundant system management unit 147 can operate the information processing unit 132 of the redundant system instead of the information processing unit 122 of the main system by transmitting the operation instruction to the electronic control device 130.

As described above, according to the on-vehicle control system 10 of the present embodiment, the electronic control devices 110 and 120 (although not illustrated, the electronic control device 130 can also be included by including an abnormality detection unit) including the abnormality detection units 112 and 123 can detect the data collected by the sensor 170 or the abnormality (security abnormality, failure) in the electronic control device, and the electronic control device 140 can determine the presence or absence of the occurrence of the security abnormality and the failure in each electronic control device and the necessity of function substitution based on the detection results. In particular, when a security abnormality occurs in each electronic control device, the electronic control device 140 can calculate an infringement estimation degree indicating a degree of influence by the security abnormality, and perform attack determination as to whether the corresponding electronic control device is subjected to a security attack based on the calculation result. Then, when an abnormality (security abnormality or failure) occurs in the electronic control device and the electronic control device 140 determines that function substitution is necessary, the electronic control device can perform security processing or failure processing according to the type of the abnormality. As a result, when the failure in which the redundant system is not damaged occurs in the function of the main system, the on-vehicle control system 10 can operate the function of the redundant system instead of the failed main system by the failure processing. On the other hand, when the security abnormality in which the redundant system is likely to be attacked occurs in the function of the main system, the on-vehicle control system can perform the response specialized for the security attack without performing the alternative operation to the redundant system by the security processing. That is, since the on-vehicle control system 10 (the electronic control device 140) according to the present embodiment can determine an appropriate coping method by distinguishing whether the cause in which the normal operation cannot be performed in each electronic control device is caused by the security attack, it is possible to continuously provide the travel control (for example, automatic driving control of an automobile) by the on-vehicle control system 10 as much as possible while securing the safety of the control by the on-vehicle control system 10. Therefore, it is possible to improve the security safety at the time of starting the redundant system while maintaining the travel control (for example, automatic driving) of the automobile by the on-vehicle control system.

### (2) Second Embodiment

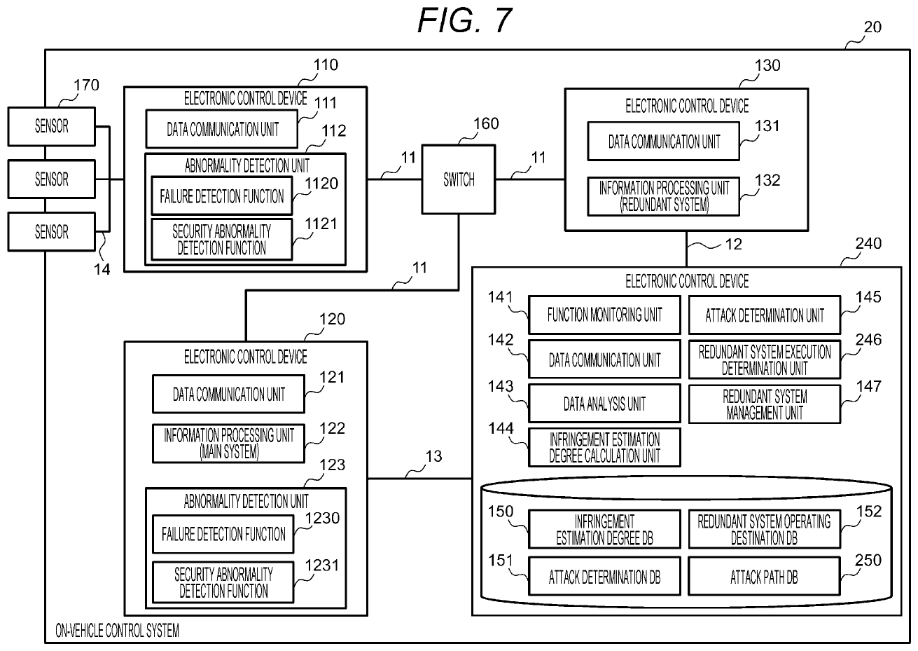

FIG. 7 is a block diagram illustrating a configuration example of an on-vehicle control system 20 according to a second embodiment of the present invention. As a difference from the on-vehicle control system 10 according to the first embodiment, the on-vehicle control system 20 according to the second embodiment enables switching to the redundant system operation in consideration of an attack path. As compared with the configuration of the on-vehicle control system 10 illustrated in FIG. 1, the on-vehicle control system 20 illustrated in FIG. 7 is different in including an electronic control device 240 instead of the electronic control device 140. The electronic control device 240 is different from the electronic control device 140 in that it includes a redundant system execution determination unit 246 that executes processing different from that of the redundant system execution determination unit 146, and an attack path database (DB) 250. Note that, in the on-vehicle control system 20 according to the second embodiment, components common to those of the on-vehicle control system 10 according to the first embodiment are denoted by the same reference numerals, and description thereof will be omitted.

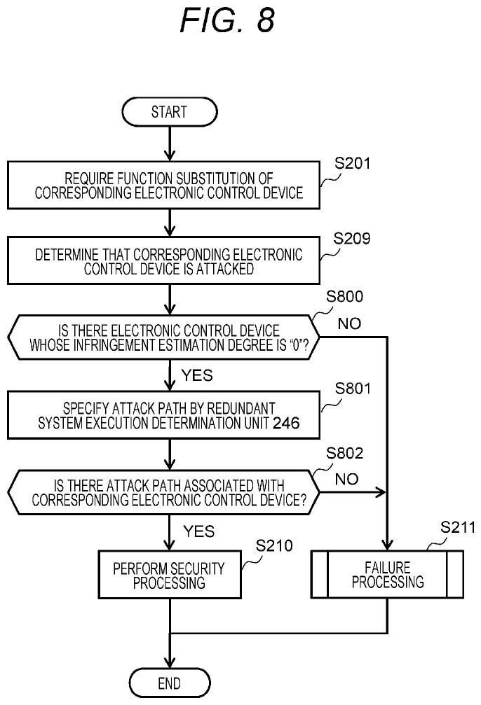

The redundant system execution determination unit 246 has a function of determining whether to operate the redundant system function in consideration of the infringement estimation degree for the electronic control device different from the electronic control device that desires to operate the redundant system function. A specific processing procedure of the processing by the redundant system execution determination unit 246 will be described later with reference to FIG. 8.

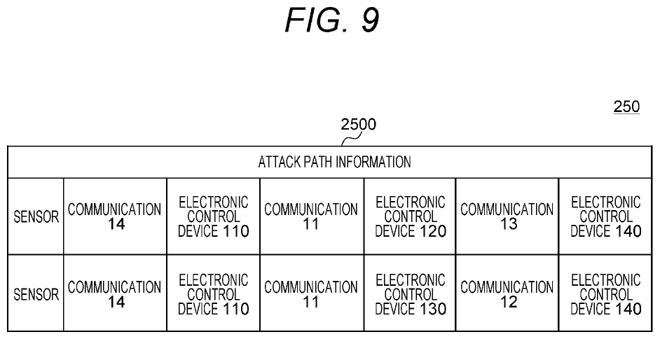

The attack path DB 250 stores an attack path from the entry point to the protective asset in the on-vehicle control system 20. The attack path DB 250 is used when the redundant system execution determination unit 246 determines whether to operate the redundant system. As an example of the protective asset, there is a function related to control of an automobile. The data structure of the attack path DB 250 will be described later with reference to FIG. 9.

FIG. 8 is a flowchart illustrating a processing procedure example of processing by the redundant system execution determination unit 246. In FIG. 8, processing similar to those illustrated in FIG. 2 is denoted by the same step number, and detailed description thereof is omitted. In the processing illustrated in FIG. 8, step S201 is executed not by the redundant system execution determination unit 246 but by the function monitoring unit 141.

According to FIG. 8, first, in step S201, the function monitoring unit 141 checks whether the electronic control device that may activate the redundant system is in a state in which function substitution is necessary. Then, in a case where it is determined in step S201 that function substitution is necessary, as described in step S209 of FIG. 2, the redundant system execution determination unit 146 refers to the attack determination DB 151 to confirm whether an appropriate electronic control device that requires function substitution has been determined as to be under attack. In FIG. 8, the subsequent processing is illustrated on the assumption that the corresponding electronic control device that requires function substitution is determined as to be under attack in step S209.

In the next step S800, the redundant system execution determination unit 246 refers to the attack determination DB 151 and confirms whether there is an electronic control device whose infringement estimation degree 1512 is not “0”. In a case where the infringement estimation degree 1512 is “0” in all the electronic control devices (electronic control device names 1510) registered in the attack determination DB 151 (NO in step S800), the process proceeds to step S211, and the failure processing described in FIG. 2 is performed. On the other hand, when at least one electronic control device (electronic control device name 1510) whose infringement estimation degree 1512 is not “0” is registered in the attack determination DB 151 (YES in step S800), the process proceeds to step S801.

In step S801, the redundant system execution determination unit 246 uses the attack path DB 250 to specify an attack path related to the electronic control device of which the infringement estimation degree checked in step S800 is other than “0” from the attack path information 2500 (see FIG. 9).

In the next step S802, the redundant system execution determination unit 246 checks whether the corresponding electronic control device to which function substitution is desired to be performed is included in the attack path specified in step S801. When the corresponding electronic control device to which function substitution is desired to be performed is not included in the path (NO in step S802), the process proceeds to step S211, and failure processing is performed. On the other hand, in a case where the corresponding electronic control device to which function substitution is desired to be performed is included in the path (YES in step S802), the process proceeds to step S210, and the security processing is performed.

As described above, when receiving data from another electronic control device, in a case where function substitution is necessary in a certain electronic control device and attack determination is made, the electronic control device 240 can perform the security processing in step S210 or the failure processing in step S211 according to the abnormal state as a result of executing the processing in steps S800 to S802. At this time, in particular, the redundant system execution determination unit 246 determines to perform the security processing in a case where an electronic control device that requires function substitution is included in the attack path related to the electronic control device of which the infringement estimation degree is other than “0”. As described in FIG. 2, the redundant system of the corresponding electronic control device is not activated in the security processing performed in step S210, and the redundant system of the corresponding electronic control device is activated and operated in the failure processing performed in step S211. As a result, the on-vehicle control system 20 (electronic control device 240) can realize switching to the redundant system operation in consideration of the attack path.

In addition, as another processing procedure of the failure processing in the present embodiment, for example, the redundant system execution determination unit 146 may specify all attack paths including the corresponding electronic control device for which function substitution is desired to be performed with reference to the attack determination DB 151 in step S801, and determine whether there is an electronic control device whose infringement estimation degree is other than “0” on the specified attack path in step S802. Also in the processing procedure of steps S801 to S802, the redundant system execution determination unit 146 can check whether there is an electronic control device to which function substitution is desired to be performed on the attack path including the electronic control device subjected to the security attack (on the path likely to be subjected to the security attack).

FIG. 9 is a diagram illustrating an example of the attack path DB 250. The attack path DB stores an attack path from the entry point to the protective asset in the on-vehicle control system 20, and specifically, in the case of FIG. 9, the attack path DB 250 includes a data item of attack path information 2500. Note that the attack path indicates a path through which a security attack is transmitted when the attack is performed, and generally corresponds to a connection path between devices.

Information indicating an attack path from the entry point to the protective asset is registered in the attack path information 2500. Specifically, in the attack path DB 250 of FIG. 9, when a sensor (for example, one of the sensors 170) is set as an entry point and an electronic control device (electronic control devices 110 to 140) related to travel control is set as a protective asset, two attack paths from the sensor to the electronic control device 140 are registered as the attack path information 2500. Note that “communication 11” to “communication 14” in the attack path information 2500 of FIG. 9 correspond to the communication bus 11 to the communication bus 14.

Note that the attack path that can be considered by the on-vehicle control system 20 according to the second embodiment at the time of switching to the redundant system operation is not limited to the connection configuration of FIG. 7, and can be applied to various connection configurations. Switching to the redundant system operation will be described below by exemplifying a case where the on-vehicle control system 20 has a connection configuration of an electronic control device more complicated than that in FIG. 7.

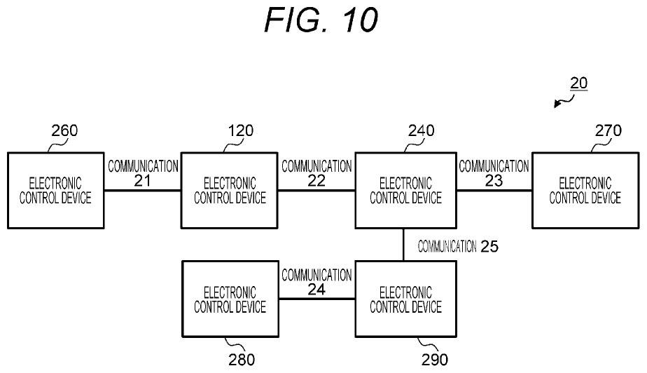

FIG. 10 is a block diagram illustrating another example of the connection configuration of the electronic control device in the on-vehicle control system 20. The on-vehicle control system 20 illustrated in FIG. 10 is configured by connecting more electronic control devices than those illustrated in FIG. 7. Note that the communication 21 to the communication 25 connecting the electronic control devices are communication paths formed by a communication bus.

In FIG. 10, for example, each of electronic control devices 260, 270, 280, and 290 is an electronic control device having a function similar to those of the electronic control devices 110, 120, and 130. As illustrated in FIG. 10, the electronic control device 260 is connected to the electronic control device 120 via the communication 21. The electronic control device 120 is connected to the electronic control device 260 via the communication 21, and is connected to the electronic control device 240 via the communication 22. The electronic control device 240 is connected to the electronic control device 120 via the communication 22, connected to the electronic control device 270 via the communication 23, and connected to the electronic control device 290 via the communication 25. The electronic control device 270 is connected to the electronic control device 240 via the communication 23. The electronic control device 280 is connected to the electronic control device 290 via the communication 24. The electronic control device 290 is connected to the electronic control device 280 via the communication 24, and is connected to the electronic control device 240 via the communication 25.

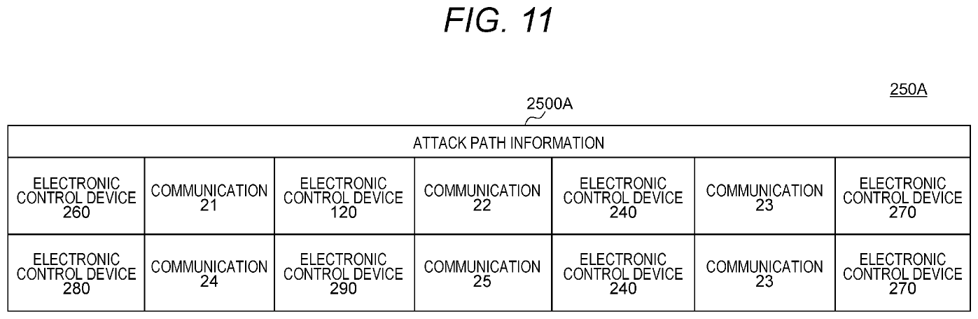

FIG. 11 is a diagram illustrating an example of an attack path DB 250A in the connection configuration of FIG. 10. In the attack path DB 250A of FIG. 11, it is assumed that the electronic control device 270 has a function related to travel control, and an attack path from the entry point (electronic control devices 260 and 280) to the protective asset (electronic control device 270) is registered in attack path information 2500A.

Here, by specifically showing the processing procedure of steps S800 to S802 of FIG. 8 using the attack path DB 250A of FIG. 11, a processing flow of whether to operate a redundant system that substitutes the electronic control device 120 in two situations (first situation, second situation) will be described.

First, in the first situation, it is assumed that the electronic control device 120 is not subjected to attack determination in step S800, but the infringement estimation degree of the electronic control device 260 is not “0”. At this time, since there is an electronic control device 260 of which the infringement estimation degree is not “0” according to the above assumption in step S800, the process proceeds to step S801, and the redundant system execution determination unit 246 of the electronic control device 240 specifies the attack path with reference to the attack path DB 250A in FIG. 11. Specifically, in step S801, a record in the first row of the data row of the attack path information 2500A is specified as the attack path related to the electronic control device 260. In the next step S802, since the electronic control device 120 to which function substitution is desired to be performed is included in the attack path specified in step S801, the redundant system execution determination unit 246 determines “YES”. That is, since the electronic control device 120 to which function substitution is desired to be performed is present on the attack path of the electronic control device 260, the process proceeds to step S210, and the security processing is performed without operating the redundant system. Here, in a similar first situation, when the process in the first embodiment is confirmed according to the process flow in FIG. 2, since the electronic control device 120 is not determined to be attacked, the redundant system execution determination unit 146 determines NO in step S209, and activation of the redundant system (execution of failure processing) is determined. However, in the second embodiment, by executing the processing flow of FIG. 8 as described above, in a case where a sign of a security attack is slightly detected by the electronic control device existing on the attack path (the infringement estimation degree other than “0” is calculated), a measure for operating the redundant system is not selected, and thus security safety at the time of activation of the redundant system can be enhanced as compared with the first embodiment.

Next, in the second situation, it is assumed that the electronic control device 120 is not subjected to the attack determination in step S800, and the infringement estimation degree of the electronic control device 280 is not “0”. At this time, since there is an electronic control device 280 of which the infringement estimation degree is not “0” according to the above assumption in step S800, the process proceeds to step S801, and the redundant system execution determination unit 246 of the electronic control device 240 specifies the attack path with reference to the attack path DB 250A in FIG. 11. Specifically, in step S801, a record in the second row of the data row of the attack path information 2500A is specified as the attack path related to the electronic control device 280. In the next step S802, since the electronic control device 120 to which function substitution is desired to be performed is not included in the attack path specified in step S801, the redundant system execution determination unit 246 determines “NO”. That is, in the second situation, unlike the first situation, since the electronic control device 120 to which function substitution is desired to be performed does not exist on the attack path of the electronic control device 280, the process proceeds to step S211, and failure processing of operating the redundant system is performed. In other words, in the second situation, even if the electronic control device 280 does not have the infringement estimation degree of “0” and is subjected to some security attack, the operation of the situation system substituted for the electronic control device 120 is not affected. Therefore, it is possible to switch to the redundant system while maintaining security safety.

As described above, in the on-vehicle control system 20 according to the second embodiment, when the security attack and the failure occur at the same time, the redundant system can be prevented from being operated for the failure possibly derived from the attack (first situation), and the redundant system can be operated for the failure not derived from the attack (second situation). Therefore, for example, the function of the travel control by the electronic control device 270 can be continuously provided.

### (3) Third Embodiment

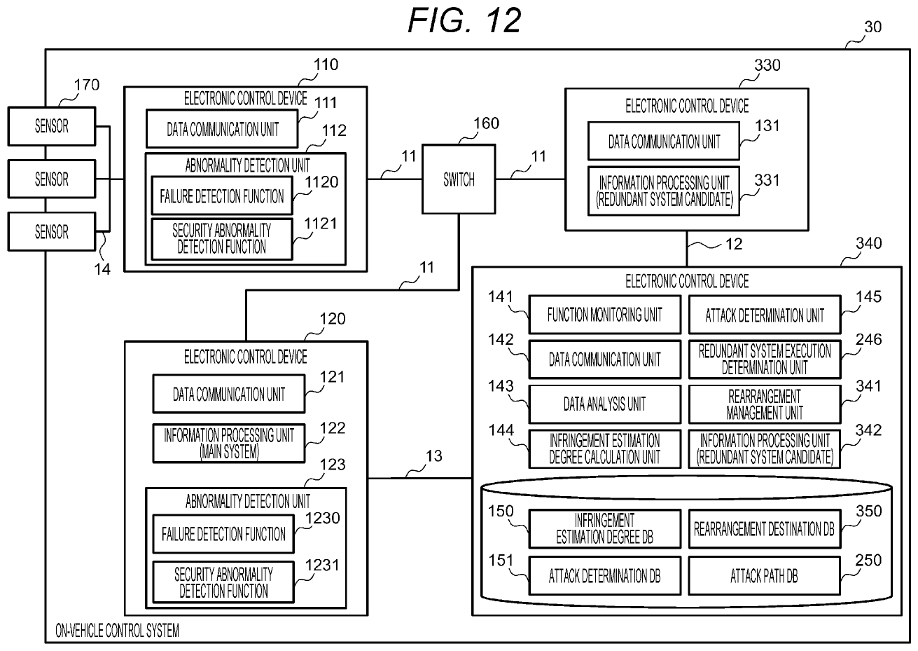

FIG. 12 is a block diagram illustrating a configuration example of an on-vehicle control system 30 according to a third embodiment of the present invention. As compared with the on-vehicle control systems 10 and 20 according to the first or second embodiment, the on-vehicle control system 30 according to the third embodiment is characterized in that the operating destination of the redundant system is not determined (specified) at the design stage, and when the redundant system is to be operated, a rearrangement management unit 341 of an electronic control device 340 needs to determine the rearrangement destination (operating destination) of the redundant system using the rearrangement destination database (DB) 350. A plurality of candidates for the rearrangement destination of the redundant system can be prepared. In the third embodiment, similarly to the second embodiment, switching to the redundant system operation in consideration of the attack path is enabled. Note that, in the on-vehicle control system 30 according to the third embodiment, the same reference numerals are given to the configurations common to the on-vehicle control systems 10 and 20 according to the first or second embodiment, and the description thereof will be omitted.

As illustrated in FIG. 12, the on-vehicle control system 30 includes an electronic control device 340 instead of the electronic control device 140 of the on-vehicle control system 10 or the electronic control device 240 of the on-vehicle control system 20. The electronic control device 340 does not include the redundant system management unit 147, but includes the rearrangement management unit 341, an information processing unit 342 of a redundant system candidate, and the rearrangement destination database (DB) 350. Further, in the on-vehicle control system 10 and the like, the electronic control device 130 includes the redundant system information processing unit 132, but in the on-vehicle control system 30, an electronic control device 330 includes an information processing unit 331 of a redundant system candidate.

The rearrangement management unit 341 uses the rearrangement destination DB 350, the attack determination DB 151, and the attack path DB 250 to determine a rearrangement destination (operating destination) of the redundant system that substitutes for the information processing unit 122 of the main system. In a case where there are a plurality of candidates as the rearrangement destination of the redundant system, the rearrangement management unit 341 determines the rearrangement destination (operating destination) of the redundant system by giving priority to an electronic control device having a resource margin or an electronic control device having less (short) data routing. In addition, a more appropriate operating destination of the redundant system may be determined by combining conditions of an electronic control device or the like that does not exist on the attack path.

The information processing unit 331 of the redundant system candidate included in the electronic control device 330 and the information processing unit 342 of the redundant system candidate included in the electronic control device 340 are candidates for the operating destination of the redundant system in a case where the information processing unit 122 of the main system in the electronic control device 120 cannot perform the regular operation. The information processing units 331 and 342 have a function of substituting a function (redundant function) similar to or a part of the function of the information processing unit 122.

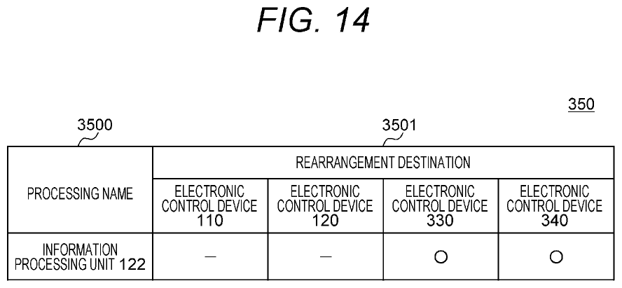

The rearrangement destination DB 350 stores definitions at a design stage for candidates for a rearrangement destination (operating destination) of a redundant system corresponding to an information processing unit of a main system. In the third embodiment, since one rearrangement destination of the redundant system is not determined and a plurality of candidates can be prepared, one rearrangement destination is determined by the rearrangement management unit 341 from among a plurality of candidates defined in the rearrangement destination DB 350. The data structure of the rearrangement destination DB 350 will be described later with reference to FIG. 14.

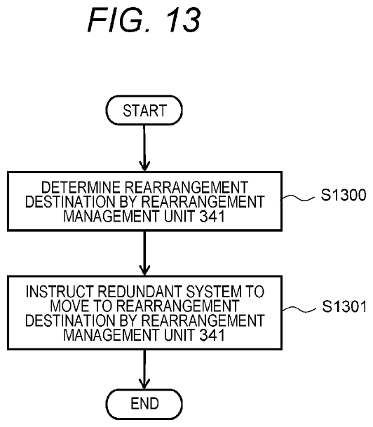

FIG. 13 is a flowchart illustrating a detailed processing procedure example of failure processing in the third embodiment. The failure processing illustrated in FIG. 13 is processing performed by the rearrangement management unit 341 in the failure processing in step S211 illustrated in FIG. 2 or 8 in the third embodiment.

When execution of failure processing is determined after failure determination for the information processing unit 122 of the main system, first, the rearrangement management unit 341 determines an electronic control device to rearrange a redundant function to be substituted for the function of the information processing unit 122 (step S1300). The rearrangement destination DB 350 and the attack path DB 250 are used to determine the rearrangement destination. Then, when the attack path candidate can be specified with reference to the attack path DB 250, the redundant system is not rearranged in the electronic control device on the specified attack path.

Next, the rearrangement management unit 341 prepares for the redundant system operation, and transmits an operation instruction of the redundant system to the rearrangement destination of the redundant system determined in step S1300 (step S1301).

FIG. 14 is a diagram illustrating an example of the rearrangement destination DB 350. The rearrangement destination DB 350 stores candidates for the rearrangement destination of the redundant system defined in the design stage. Specifically, in the case of FIG. 14, the rearrangement destination DB is configured to include a processing name 3500 and data items of a rearrangement destination 3501.

The processing name 3500 stores a processing name implemented in an electronic control device in the on-vehicle control system 30. However, the processing name stored in the processing name 3500 is limited to processing designed as processing that may operate a redundant system when an abnormality occurs in a preliminary design stage. FIG. 14 illustrates an example in which the information processing unit 122 of the main system mounted on the electronic control device 120 is registered in the processing name 3500.

In the rearrangement destination 3501, a candidate for the rearrangement destination of the redundant system in a case where a failure occurs in the processing registered in the processing name 3500 and the normal operation cannot be performed is registered. In the rearrangement destination 3501 of FIG. 14, an example is illustrated in which the electronic control device 330 on which the information processing unit 331 is mounted and the electronic control device 340 on which the information processing unit 342 is mounted are marked with “o”, so that the electronic control devices 330 and 340 are registered as candidates for the rearrangement destination of the redundant system of the information processing unit 122.

As described above, in the on-vehicle control system 30 according to the third embodiment, in the system configuration on the premise of the rearrangement of the redundant system, when a failure occurs in a certain electronic control device, an appropriate rearrangement destination can be determined from among the candidates of the rearrangement destination defined in the design stage according to the situation at the time of the occurrence of the failure, and the redundant system can be operated at the rearrangement destination. Therefore, switching to the redundant system can be performed while security is maintained.

Further, the present invention is not limited to the above embodiments, but includes various modifications. For example, the above-described embodiments of the present invention have been described in detail in a clearly understandable way, and are not necessarily limited to those having all the described configurations. In addition, some of the configurations of a certain embodiment may be replaced with the configurations of the other embodiments, and the configurations of the other embodiments may be added to the configurations of the subject embodiment. In addition, some of the configurations of each embodiment may be omitted, replaced with other configurations, and added to other configurations.

Each of the above configurations, functions, processing units, processing means, and the like may be partially or entirely achieved by hardware by, for example, designing by an integrated circuit. Each of the above configurations, functions, and the like may be achieved by software by a processor interpreting and executing a program that achieves each function. The information such as the programs, tables, files, and the like for realizing the respective functions can be placed in a recording device such as a memory, a hard disk, or a Solid State Drive (SSD), or a recording medium such as an IC card, an SD card, a DVD, or the like.

Only control lines and information lines considered to be necessary for explanation are illustrated in the drawings, but not all the control lines and the information lines for a product are illustrated. In practice, almost all the configurations may be considered to be connected to each other.

### REFERENCE SIGNS LIST

10, 20, 30 on-vehicle control system
11 to 14, 21 to 25 communication bus
110, 120, 130, 140, 240, 260, 270, 280, 290, 330, 340 electronic control device
111, 121, 131, 142 data communication unit
112, 123 abnormality detection unit
122, 132, 331, 342 information processing unit
141 function monitoring unit
143 data analysis unit
144 infringement estimation degree calculation unit
145 attack determination unit
146, 246 redundant system execution determination unit
147 redundant system management unit
150 infringement estimation degree database (DB)
151 attack determination database (DB)
152 redundant system operating destination database (DB)
160 switch
170 sensor
250, 250A attack path database (DB)
341 rearrangement management unit
350 rearrangement destination database (DB)
1120, 1230 failure detection function
1121, 1231 security abnormality detection function

1. An electronic control device mounted on an on-vehicle control system that performs travel control of an automobile and communicatively connected to a plurality of control devices including a first control device and a second control device, the electronic control device comprising:
an attack determination unit that determines presence or absence of a security attack in each control device of the plurality of control devices; and
a redundant system execution determination unit that determines, based on a result of determination by the attack determination unit, whether to cause the second control device to alternatively execute a redundant function similar to the function performed by the first control device or a part of the function.

2. The electronic control device according to claim 1, further comprising:
a function monitoring unit that monitors an operation of each of the control devices and determines whether substitution of the function by each of the control devices is necessary, wherein
when the function monitoring unit determines that substitution of the function by the first control device is necessary,
the redundant system execution determination unit is configured to:
in a case where the attack determination unit determines that there is no security attack in the first control device, cause the second control device to execute the redundant function corresponding to the function; and
in a case where the attack determination unit determines that there is a security attack in the first control device, cause predetermined security processing to be performed on the first control device without substituting the second control device for the redundant function corresponding to the function.

3. The electronic control device according to claim 1, further comprising:
an infringement estimation degree calculation unit that calculates an infringement estimation degree indicating a possibility that a security attack has occurred in each of the control devices, wherein
the attack determination unit determines presence or absence of the security attack in each of the control devices based on the infringement estimation degree calculated by the infringement estimation degree calculation unit.

4. The electronic control device according to claim 3, further comprising:
a data communication unit that receives abnormality detection information indicating a security abnormality detected by the first control device, wherein
the infringement estimation degree calculation unit calculates the infringement estimation degree in the first control device based on the abnormality detection information received by the data communication unit.

5. The electronic control device according to claim 2, further comprising:
attack path information indicating an attack path of a security attack assumed in the on-vehicle control system, wherein
when the attack determination unit determines that there is a security attack in the first control device,
the redundant system execution determination unit is configured to:
specify the attack path that which is likely to be affected by the security attack based on the attack path information, and determine whether the second control device exists on the specified attack path; and
cause the second control device to execute the redundant function when the second control device does not exist on the attack path, and does not cause the second control device to alternatively execute the redundant function when the second control device exists on the attack path.

6. The electronic control device according to claim 1, wherein
a candidate of the second control device that can alternatively execute the corresponding redundant function is predefined for each function by the first control device,
the electronic control device further comprises a rearrangement management unit that manages which of the defined candidates the redundant function is alternatively executed when the redundant system execution determination unit determines to cause the second control device to alternatively execute the redundant function corresponding to the function by the first control device.

7. The electronic control device according to claim 1, wherein
the second control device that alternatively executes the redundant function can include an own electronic control device.

8. An on-vehicle control system that performs travel control of an automobile, the on-vehicle control system comprising:
a plurality of control devices that include a first control device having a predetermined function and a second control device having a redundant function similar to the function or a part of the function; and
an electronic control device that is communicatively connected to the plurality of control devices, wherein
the electronic control device includes:
an attack determination unit that determines presence or absence of a security attack in each control device of the plurality of control devices; and
a redundant system execution determination unit that determines, based on a result of determination by the attack determination unit, whether to cause the second control device to alternatively execute the redundant function corresponding to the function performed by the first control device.

9. A redundant function control method by an electronic control device mounted on an on-vehicle control system that performs travel control of an automobile and communicatively connected to a plurality of control devices including a first control device and a second control device, the method comprising:
determining presence or absence of a security attack in each control device of the plurality of control devices; and
determining, based on a result of determination of the determining of an attack, whether to cause the second control device to execute a redundant function similar to the function performed by the first control device or a part of the function.
